(19) United States
(12) Patent Application Publication
(10) Pub. No.: US 2015/0206153 A1
(43) Pub. Date: Jul. 23, 2015

(54) METHOD AND SYSTEM FOR INDEXING CONSUMER SENTIMENT OF A MERCHANT

(71) Applicant: MASTERCARD INTERNATIONAL INCORPORATED, Purchase, NY (US)

(72) Inventor: Edward Lee, Scarsdale, NY (US)

(73) Assignee: MASTERCARD INTERNATIONAL INCORPORATED, Purchase, NY (US)

(21) Appl. No.: 14/159,766

(22) Filed: Jan. 21, 2014

(51) Int. Cl. G06Q 30/02; G06F 17/30; G06Q 50/00

(52) U.S. Cl. CPC G06Q 30/0201; G06Q 50/01; G06F 17/30312

(57) ABSTRACT

A method and a system are provided for indexing consumer sentiment of a merchant. The method includes retrieving from one or more databases a first set of information comprising categorization of merchants, and retrieving from one or more databases a second set of information comprising social media information indicative of consumer sentiment of a merchant for a defined time period. The method further includes generating one or more indices based on the first set of information and the second set of information, and assessing consumer sentiment of a merchant, based on the one or more indices. The systems and methods are provided for determining consumer sentiment trending for a merchant relative to its industry. The systems and methods determine how consumers feel about a merchant relative to the merchant's industry by indexing. The indices can be trended over time.

### BACKGROUND OF THE DISCLOSURE

1. Field of the Disclosure

The present disclosure relates to a method and a system for indexing consumer sentiment of a merchant. In particular, one or more indices are generated based on merchant categorization information and social media information indicative of consumer sentiment of a merchant for a defined time period. Based on the one or more indices, consumer sentiment of that merchant is assessed.

2. Description of the Related Art

Entities, such as large companies, want to monitor the public's sentiment, or perception of their company, product, organization, or the like. For example, the general public may comment on a company in a variety of media, including social media sites, microblogs, blogs, video posting sites, and a variety of other websites. By way of example, a company will likely benefit from knowing the public's current sentiment regarding a product, for example, (the current “buzz”) as to whether the product is noticed in general following a marketing campaign, whether the product is liked or disliked, and so forth. The company's overall reputation is also important to know.

Websites that allow users to interact with one another have exploded in popularity in the last few years. Social networking websites sites, such as FACEBOOK® and LINKEDIN®, and microblogging websites such as TWITTER®, enjoy widespread use. Millions of users post messages, images and videos on such websites on a daily, even hourly basis, oftentimes report events on a real-time or near-time basis, and reveal the user's activities and interests. Users typically direct messages to specific persons, their social group, or perhaps merchants or businesses maintaining a presence on the social networking websites. Such messages are oftentimes visible to the general public.

Such publicly accessible social media represents a potentially rich mine of information that can provide insight into the public's current sentiment regarding merchants and businesses. Such information may be of great interest to various types of merchants or business organizations. For example, a network provider may wish to track or monitor all messages describing network problems across the country on a real time basis. In another example, a national hotel chain may wish to track or monitor all messages relating to its hotel services, and in particular, messages reporting problems experienced by hotel guests.

It would be desirable for a merchant to monitor and index public sentiment, or perception of its business, product, organization, or the like, to trend the index over time, and to compare and contrast the index with other merchants (e.g., competitors) in the industry sector over time.

### SUMMARY OF THE DISCLOSURE

The present disclosure provides a method and a system for indexing consumer sentiment of a merchant. In particular, one or more indices are generated based on merchant categorization information and social media information indicative of consumer sentiment of a merchant for a defined time period. Based on the one or more indices, consumer sentiment of that merchant is assessed.

The present disclosure provides a method that involves retrieving from one or more databases a first set of information comprising categorization of merchants, and retrieving from the one or more databases a second set of information comprising social media information indicative of consumer sentiment of a merchant for a defined time period. The method further involves generating one or more indices based on the first set of information and the second set of information, and assessing consumer sentiment of that merchant, based on the one or more indices.

The present disclosure also provides a system that includes one or more databases comprising a first set of information including categorization of merchants, and one or more databases comprising a second set of information including social media information indicative of consumer sentiment of a merchant for a defined time period. The system includes a processor that is configured to generate one or more indices based on the first set of information and the second set of information, and assess consumer sentiment of that merchant, based on the one or more indices.

### BRIEF DESCRIPTION OF THE DRAWINGS

FIG. 1 is a flow chart illustrating a method for indexing consumer sentiment of a merchant in accordance with exemplary embodiments of this disclosure.

FIG. 2 shows illustrative merchants in selected industry categories in accordance with exemplary embodiments of this disclosure.

FIG. 3 illustrates a high-level view of social media data mining analysis in the context of a network of users and social media sources in accordance with exemplary embodiments of this disclosure.

FIG. 4 illustrates a detailed view of a server used in social media data mining analysis in accordance with exemplary embodiments of this disclosure.

FIG. 5 illustrates a method for social media data mining in accordance with exemplary embodiments of this disclosure.

FIG. 6 shows a block diagram of a data processing system that can be used in social media data mining in accordance with exemplary embodiments of this disclosure.

A component or a feature that is common to more than one drawing is indicated with the same reference number in each drawing.

### DESCRIPTION OF THE PREFERRED EMBODIMENTS

Embodiments of the present disclosure are described more fully hereinafter with reference to the accompanying drawings, in which some, but not all, embodiments of the disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, “social media” refers to any type of electronically-stored information that users send or make available to other users for the purpose of interacting with other users in a social context. Such media can include directed messages, status messages, broadcast messages, audio files, image files and video files. Reference in this disclosure to “social media websites” should be understood to refer to any website that facilitates the exchange of social media between users. Examples of such websites include social networking websites such as FACEBOOK and LINKEDIN, and microblogging websites such as TWITTER. Social media also refers to newspapers and magazines.

As used herein, the one or more databases configured to store the first set of information or from which the first set of information is retrieved, and the one or more databases configured to store the second set of information or from which the second set of information is retrieved, can be the same or different databases.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave, are included in the definition of medium. “Disk” and “disc” as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, systems, methods and computer programs are herein disclosed to determine consumer sentiment trending for a merchant relative to its industry. The systems, methods and computer programs determine how consumers feel about a merchant relative to the merchant's industry by indexing. The indices can be trended over time.

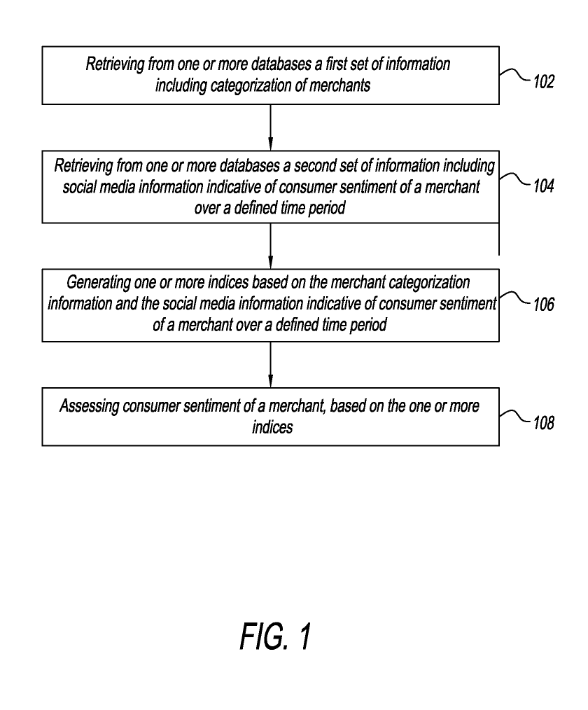

Referring to FIG. 1, a first set of information comprising categorization of merchants is retrieved from one or more databases at 102. A second set of information comprising social media information indicative of consumer sentiment of a merchant for a defined time period is retrieved from one or more databases at 104. One or more indices are generated at 106 based on the first set of information (i.e., merchant categorization) and the second set of information (i.e., social media information indicative of consumer sentiment of a merchant for a defined time period). Consumer sentiment of a merchant is assessed at 108, based on the one or more indices.

Illustrative indices include, for example, indices that are a measure of the degree to which merchant positive sentiment and merchant overall sentiment are correlated for a defined time period, indices that are a measure of the degree to which industry positive sentiment and industry overall sentiment are correlated for a defined time period, and indices that are a measure of the degree to which merchant positive sentiment and industry positive sentiment are correlated for the defined time period. Indices involving merchant negative sentiment and industry negative sentiment are also part of this disclosure.

In particular, one or more databases are provided that comprise a first set of information. The first set of information includes categorization of merchants. The one or more databases are used for storing profiles of one or more merchants, and merchants belonging to a particular category, e.g., industry category. Illustrative merchant categories are described herein.

A merchant category can be determined according to the requirements of the analysis to be conducted. For example, a merchant category can include all merchants within a particular industry. Such a delineation can be used where a party wishes to generate one or more indices that are a measure of the degree to which merchant positive sentiment and industry positive sentiment are correlated for a defined time period, or generate one or more indices that are a measure of the degree to which merchant positive sentiment and industry positive sentiment are correlated for a defined time period, or generate one or more indices that are a measure of the degree to which industry positive sentiment and industry overall sentiment are correlated for a defined time period.

In other embodiments, a merchant category can include a segment of a particular industry (such as all merchants within a particular geographic region or merchants falling within a specific price range), all merchants in two or more industries (perhaps where merchants in the industries compete for the same customers), and the like. In some embodiments, the merchant category can be defined using merchant category codes according to predefined industries, which can be aligned using standard industrial classification codes, or using the industry categorization described herein.

Merchant categorization indicates the category or categories assigned to each merchant name. As described herein, merchant category information is used primarily for purposes of indexing trends of consumer sentiment of a merchant, although other uses are possible. According to one embodiment, each merchant name is associated with only one merchant category. In alternate embodiments, however, merchants are associated with a plurality of categories as apply to their particular businesses. Generally, merchants are categorized according to conventional industry codes as defined by a selected external source (e.g., a merchant category code (MCC), Hoovers™, the North American Industry Classification System (NAICS), and the like). However, in one embodiment, merchant categories are assigned based on system operator preferences, or some other similar categorization process.

An illustrative merchant categorization including industry codes is set forth below.

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

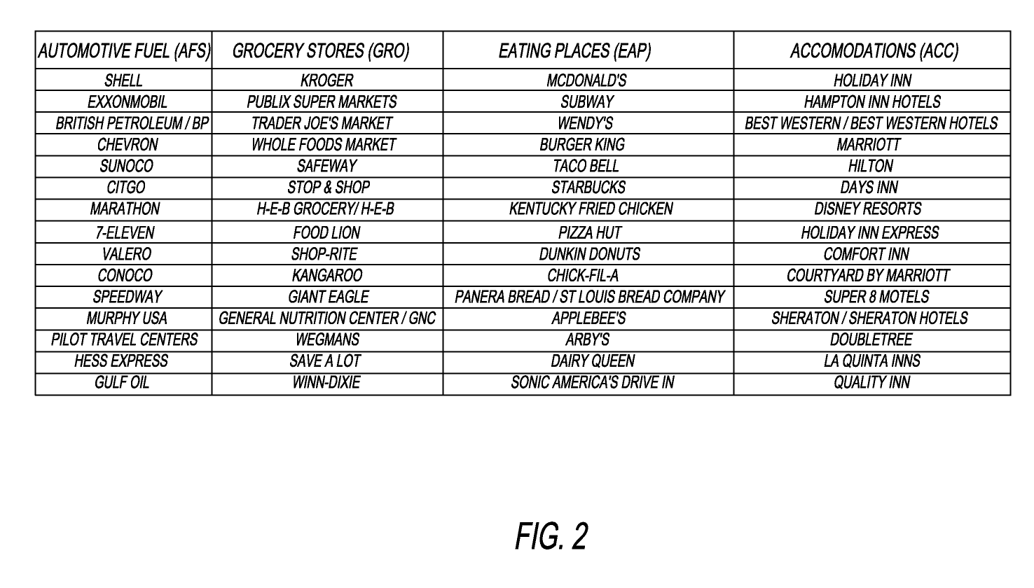

Illustrative merchants and industry categorization are shown in FIG. 2. The illustrative industry categories include AFS Automotive Fuel, GRO Grocery Stores, EAP Eating Places, and ACC Accommodations. Illustrative merchants associated with the industry categories are listed in FIG. 2. In accordance with this disclosure, merchant categorization is important for indexing trends of consumer sentiment of a merchant. Proper merchant categorization is important to obtain indexing results that are truly reflective of the particular merchant and industry, in particular, to determine how sentiment is trending for one merchant in comparison to another merchant in the same industry category.

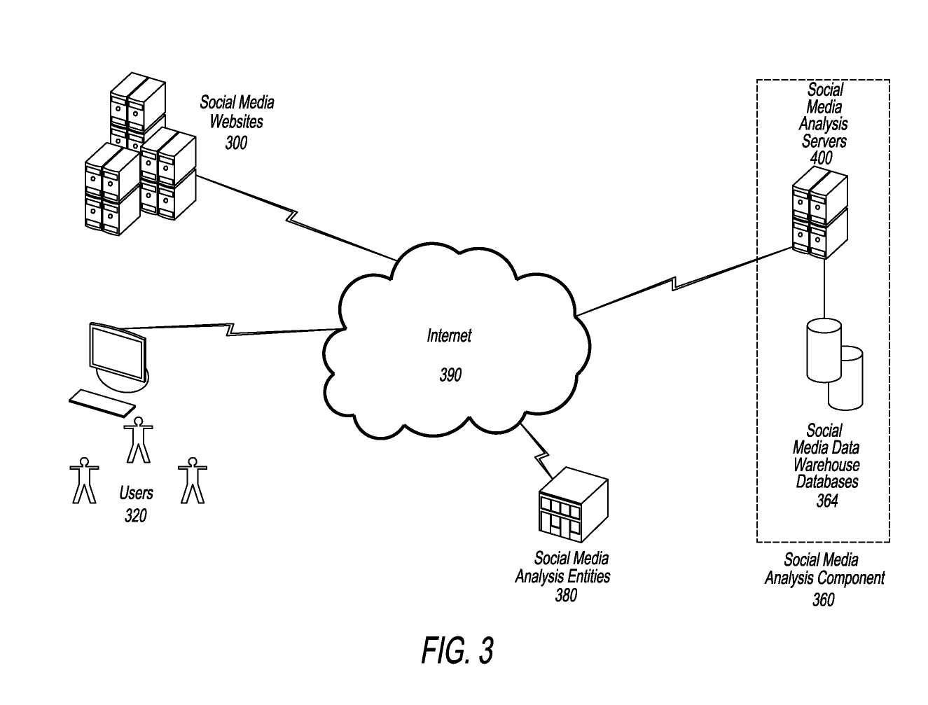

In accordance with this disclosure, one or more databases are provided that comprise a second set of information. The second set of information includes social media information indicative of consumer sentiment of a merchant for a defined time period. The second set of information is retrieved from, for example, TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines. Preferred processes for social media data mining to obtain information regarding consumer sentiment of a merchant are described herein. Illustrative embodiments of such processes for social media data mining to obtain information regarding consumer sentiment of a merchant are shown in FIGS. 3-6.

Various embodiments of the systems and methods disclosed herein collect social media gathered from a plurality of social media websites 300 (FIG. 3) and provide various interfaces and reporting functions to allow end users to track consumer sentiment of a merchant. FIG. 3 illustrates a high-level view of a social media analysis process in the context of a network of users and social media sources. A plurality of users 320 interact with one another via a plurality of social media websites 300 such as, for example, social networking and microblogging websites, via internet 390.

A social media analysis component 360 includes one or more social media analysis servers 400 that collect social media from social media websites 300 and store such social media in one or more social media data warehouse databases 364. The social media analysis servers 400 provide one or more user interfaces that allow social media analysis entities (e.g., a payment card company) 380 to view and analyze aggregated social media stored on the social media data warehouse databases 364. Such entities can include any type of business that has an interest in the content of social media. In one embodiment, the social media analysis component 360 and the social media analysis entities 380 can be within a single organization. In another embodiment, the social media analysis component 360 and the social media analysis entities 380 can be within two separate organizations.

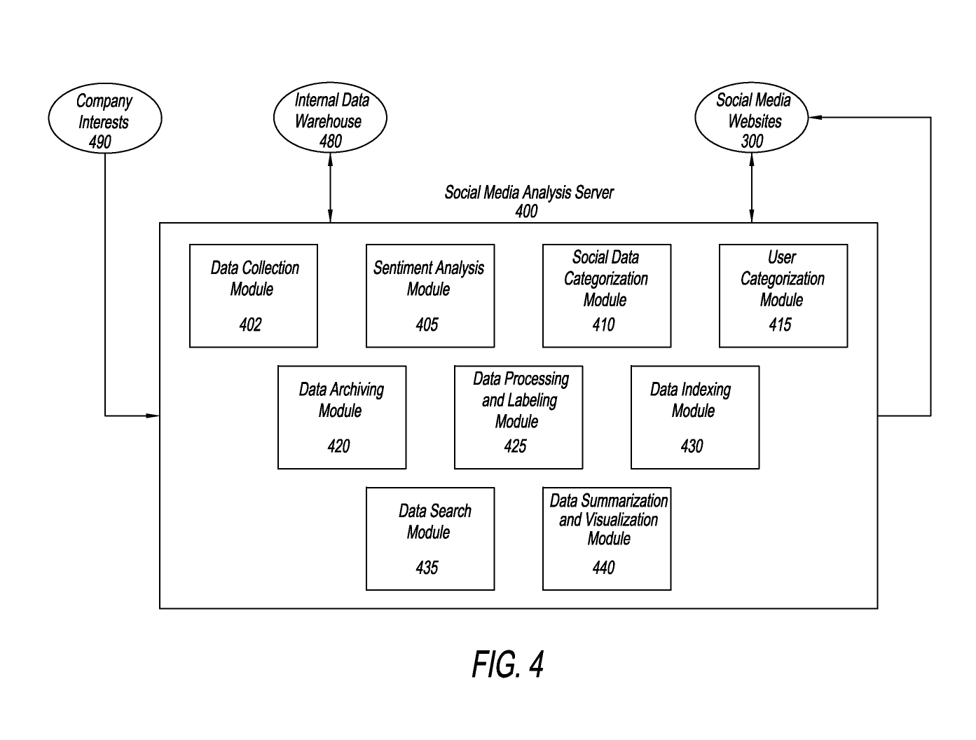

FIG. 4 illustrates a more detailed view of a social media analysis server 400. In the illustrated embodiment, social media analysis server 400 collects social media from various social media websites 300, stores the collected media in an internal data warehouse 480 and provides access to the warehoused social media to one or more entities.

The social media analysis server 400 comprises a number of modules that provide various functions related to social media collection analysis. The social media analysis server 400 includes a data collection module 402 that collects social media from social media websites 300. The data collection module 402 collects social media that relates to company interests 490, such as, for example, posts that reference the company by name, posts that relate to specific topics, and/or posts that relate to specific users.

The social media analysis server 400 includes a sentiment analysis module 405 that attempts to determine the nature of the sentiments, such as tone and mood, expressed by users in social media posts. The social media analysis server 400 includes a social data categorization module 410 that categorizes social media postings by, for example, topic, company, mood or tone. The social media analysis server 400 includes user categorization module 415 that categorizes users, for example, by various demographic characteristics or usage patterns. The social media analysis server 400 includes a data archiving module 420 that archives collected social media in the internal data warehouse 480 in association user profiles and user social connections of users relating to the social media. The social media analysis server 400 includes a data processing and labeling module 425 that labels social media data with various tags, such as categories determined by the social data categorization module 410 and the user categorization module 415. The social media analysis server 400 includes a data indexing module 430 that indexes archived social media by one or more properties. Such properties can include, for example, key words, user sentiments, or user demographics. The social media analysis server 400 includes a data search module 435 that provides facilities allowing users to search archived social media using search criteria such as, for example, one or more keywords or key phrases.

The social media analysis server 400 includes a data visualization and summarization module 440 that allows social data analysis entities to query social media archived in the internal data warehouse 480. The data visualization and summarization module 440 uses the aggregated social media, along with associated archived user profile information and user social connections to support high-level consumer sentiment of a merchant intelligence through data mining. The output of data mining and analysis is stored on a database and indexed by the data archiving module along with archived posts, user profiles, and user social connection to support expanded search capabilities. The visualization and summarization module 440 provides various views into the aggregated social media. Such visualized information can be used to better understand consumer sentiment of a merchant trending by mining the social media data.

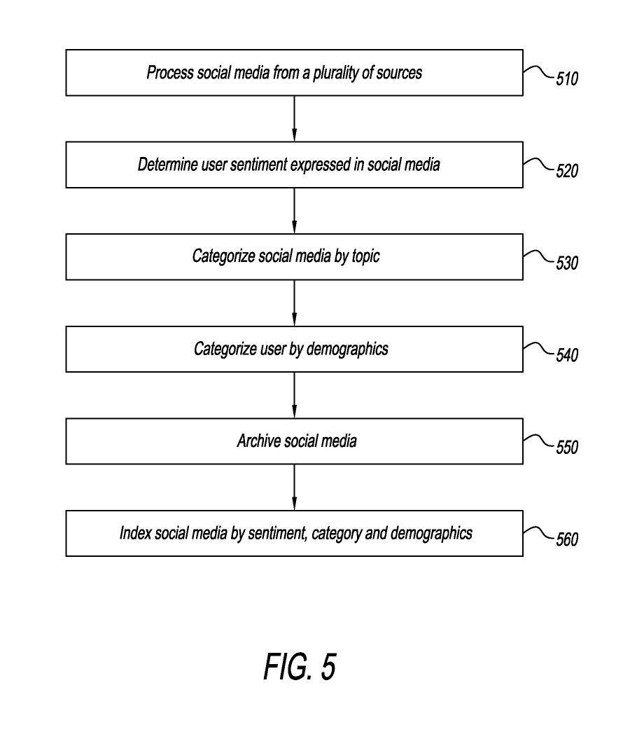

FIG. 5 illustrates a method for aggregating social media. In block 510, a process running on a server collects social media from a plurality of sources. Such sources can include social networking sites, such as FACEBOOK or LINKEDIN, or microblogging sites such as TWITTER. The process can filter the collected social media by keyword or user ID to reduce the volume of such social media. For example, the process can filter tweets based on a specific company such as “XYZ” and/or “ABC,” since a specific company may only be interested in social media posts that relate to that company. In another example, social media can be filtered by topic, for example “network,” “response time” or “DSL”. A data collection module (such as element 402 of FIG. 4) hosted on a social media analysis server performs the processing described with respect to block 510. The processing of block 510 includes parsing the social media to extract entities such as urls, locations, person names, topic tags, user ID, products, and features of products. The processing of block 510 includes estimating the location from which users submitted social media when the location is not expressly given in the social media.

In block 520, a process running on a server analyzes the social media to determine the user's sentiment, mood or purpose in posting the social media (i.e., a consumer's sentiment of a merchant). The process detects user sentiment in social media by recognizing positive words, such as “awesome,” “rock,” “love” and “beat”, and negative words such as “hate,” “stupid” and “fail.” The correlation between a sentiment and key word can vary by source. The process collects and archives only social media posts that express an opinion. The process collects and archives posts expressing an opinion only if a fixed number, for example three, of posts express the same opinion. A sentiment analysis module (such as module 405 of FIG. 4) hosted on a social media analysis server performs the processing described with respect to block 520.

In block 530, a process running on a server analyzes the social media to categorize the media by one or more topics. Such topics can include brand (e.g., “Honda” or “Coca Cola”) product type (“car” or “SUV”), or product quality (“good,” “bad” or “unreliable”). Such topics can be predefined, or the process can determine topics dynamically by consolidating social media posts from multiple users. The process can use such topics to cluster social media posts. The process can assign a priority or importance to specific topics. For example, the process can assign a topic, such as “network outage”, a higher priority than “slow response”. A social data categorization module (such as module 410 of FIG. 4) hosted on a social media analysis server performs the processing described with respect to block 530.

In block 540, a process running on a server analyzes the user posting the social media to categorize users associated with each post by one or more demographic categories. Such categories can include age, income level and interests (e.g., classical music or cross country skiing). Such categories can include user location (e.g., city, state or region). The process can determine such information from user profile data or from the content of social media posts. The process can determine such information by mining a user's social network (e.g., the user's friends on FACEBOOK, and the like). A user categorization module (such as module 415 of FIG. 4) hosted on a social media analysis server performs the processing described with respect to block 540. The processing of block 540 additionally includes determining the influence of individual users within their demographic group.

In block 550, a process running on a server archives the social media to a computer readable medium. The process can store the social media on any type of database known in the art, such as, for example, a relational database. The database can include all, or a subset of the data collected in the operation described above with respect to block 510. For example, the process can only archive data relating to specific entities (e.g. “XYZ”) and/or topics (“network” or “customer service”). A data archiving module (such as element 420 of FIG. 4) hosted on a social media analysis server performs the processing described with respect to block 550.

In addition to archiving social media with high precision and recall, the system archives user profiles and the social connections of the users associated with the social media along with the social media. The processing of block 540 collects and categorizes the user by demographics. Additionally or alternatively, the processing of block 550 includes retrieving the user profiles and social connections of users relating to the archived social media.

In block 560, a process running on a server indexes the archived social media by one or more properties. The process indexes the data to allow for efficient retrieval of social media by its properties. Such properties can include, for example, key words, user sentiments, category, or user demographics. A data indexing module (such as module 430 of FIG. 4) hosted on a social media analysis server performs the processing described with respect to block 560.

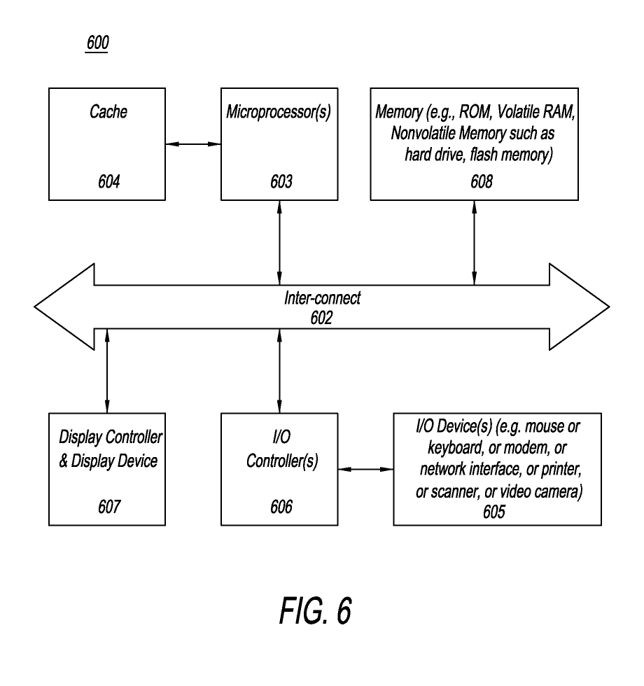

FIG. 6 shows a block diagram of a data processing system 600 that can be used in various embodiments of social media data mining. While FIG. 6 illustrates various components of a computer system, it is not intended to represent any particular architecture or manner of interconnecting the components. Other systems that have fewer or more components can also be used. One or more data processing systems, such as that shown in 600 of FIG. 6, implement the social media analysis servers 400 shown in FIGS. 3 and 4. A data processing system, such as that shown in 600 of FIG. 6, implements each of the modules 402-440 of the social media analysis server 400 of FIG. 4, where each of the modules comprises computer-executable instructions stored on the system's memory 608, such instructions being executed by the system's microprocessor 603. Other configurations are possible, as will be readily apparent to those skilled in the art.

In FIG. 6, the data processing system 600 includes an inter-connect 602 (e.g., bus and system core logic), which interconnects a microprocessor(s) 603 and memory 608. The microprocessor 603 is coupled to cache memory 604 in the example of FIG. 6.

The inter-connect 602 interconnects the microprocessor(s) 603 and the memory 608 together and also interconnects them to a display controller and display device 607 and to peripheral devices, such as input/output (I/O) devices 605, through an input/output controller(s) 606. Typical I/O devices include mice, keyboards, modems, network interfaces, printers, scanners, video cameras and other devices that are well known in the art.

The inter-connect 602 can include one or more buses connected to one another through various bridges, controllers and/or adapters. The I/O controller 606 includes a USB (Universal Serial Bus) adapter for controlling USB peripherals, and/or an IEEE-1394 bus adapter for controlling IEEE-1394 peripherals.

The memory 608 can include ROM (Read Only Memory), and volatile RAM (Random Access Memory) and non-volatile memory, such as hard drive, flash memory, and the like.

Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system that maintains data even after power is removed from the system. The non-volatile memory can also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

The social media analysis servers 400 are implemented using one or more data processing systems as illustrated in FIG. 6. In some embodiments, one or more servers of the system illustrated in FIG. 6 are replaced with the service of a peer to peer network or a cloud configuration of a plurality of data processing systems, or a network of distributed computing systems. The peer to peer network, or cloud based server system, can be collectively viewed as a server data processing system.

Embodiments of this disclosure can be implemented via the microprocessor(s) 603 and/or the memory 608. For example, the functionalities described above can be partially implemented via hardware logic in the microprocessor(s) 603 and partially using the instructions stored in the memory 608. Some embodiments are implemented using the microprocessor(s) 603 without additional instructions stored in the memory 608. Some embodiments are implemented using the instructions stored in the memory 608 for execution by one or more general purpose microprocessor(s) 603. Thus, this disclosure is not limited to a specific configuration of hardware and/or software.

In an embodiment, consumer sentiment at an aggregate or micro level is quantified for indexing purposes. Although survey data can be used to quantify consumer sentiment at an aggregate or micro level, survey data can be biased by a number of factors relevant to surveys in general. For example, survey questions are interpreted differently by different people, which can produce misleading and varying results. For example, the types of people who respond to surveys are a biased sample of the general population. For example, surveys performed over a period of time and/or a geographic region average out information across time and space, smoothing out data granularity needed for a better model of consumer behavior.

In accordance with this disclosure, social media data that records consumer communications is used to quantify consumer sentiment of a merchant. The spontaneous nature of the social media data provides better insights into true consumer sentiment of a merchant.

Social media data and other data that reflects consumer sentiment of a merchant are used to quantify the consumer sentiment at both an aggregate and micro level. Using the social media data, the system can reveal micro-granularity in consumer sentiment that is typically smoothed out in quantification results obtained via a survey approach (e.g., based on aggregating responses from questionnaires and polls).

Consumer sentiment of a merchant is established via evaluating consumer sentiment information derived from one or more different social media data sources, such as social network feeds, news feeds, and the like. Such social media data sources are analyzed to quantify consumer sentiment, and to establish indexing that allows the trending of quantified consumer sentiment based on the current social media data. The consumer sentiment of the merchant can be designated as positive, negative or neutral.

A computing system is configured to digest certain social media data sources and extract consumer sentiment of a merchant content from these data sources. After adjusting for regional and temporal differences, the consumer sentiment of a merchant content is matched with merchant categorization data to build indexing that provide an accurate view of trending consumer sentiment of a merchant for a defined time period. The indexing can be used to quantify future consumer sentiment of a merchant, thereby providing near real time measurement of consumer sentiment of a merchant at various summary levels.

In accordance with this disclosure, indexing can be used to find sentiment trending for a merchant relative to its industry. By indexing, an entity can determine how a customer feels about a merchant relative to the merchant's industry. The indexing is based on merchant categorization and social media information indicative of consumer sentiment of a merchant for a defined time period.

Illustrative indexing includes, for example, indices that are a measure of the degree to which merchant positive sentiment and merchant overall sentiment are correlated for a defined time period, indices that are a measure of the degree to which industry positive sentiment and industry overall sentiment are correlated for a defined time period, and indices that are a measure of the degree to which merchant positive sentiment and industry positive sentiment are correlated for the defined time period. Indices involving merchant negative sentiment and industry negative sentiment are also part of this disclosure.

For example, in a particular merchant categorization such as eating places (EAP), the social media (i.e., TWITTER) is mined to determine customer sentiment for a restaurant for a particular period of time. The mining shows 5100 tweets having positive sentiment and 1200 tweets having negative sentiment for a restaurant for a first month period. Subsequent mining shows 5200 tweets having positive sentiment and 1100 tweets having negative sentiment for the restaurant for a second month period. The index of merchant positive sentiment to merchant overall sentiment for the first month period is 5100/6300 that is equal to 0.81. The index of merchant positive sentiment to merchant overall sentiment for the second month period is 5200/6300 that is equal to 0.83. Thus, the index of merchant positive sentiment to merchant overall sentiment is trending upward for this two month period.

For another example, in a particular merchant categorization such as eating places (EAP), the social media (i.e., TWITTER) is mined to determine customer sentiment for the eating places industry for a particular period of time. The mining shows 28300 tweets having positive sentiment and 13300 tweets having negative sentiment for the eating places industry for a first month period. Subsequent mining shows 27300 tweets having positive sentiment and 14300 tweets having negative sentiment for the eating places industry for a second month period. The index of industry positive sentiment to industry overall sentiment for the first month period is 28300/41600 that is equal to 0.68. The index of industry positive sentiment to industry overall sentiment for the second month period is 27300/41600 that is equal to 0.66. Thus, the index of industry positive sentiment to industry overall sentiment is trending downward for this two month period.

An indexing score can be used for assessing consumer sentiment of a merchant. The indexing score can be trended over time. Proper merchant categorization is important for obtaining indexing results that are truly reflective of the particular merchant and industry, in particular, for determining how sentiment is trending for one merchant in comparison to another merchant in the same industry category.

The indexing can be updated or refreshed at a specified time (e.g., on a regular basis or upon request of a party). Updating the indexing can include updating the social media data, and optionally demographic data and/or updated geographic data. Indexing can also be updated by changing the attributes that define each merchant, and generating a different merchant categorization. The process for updating indexing can depend on the circumstances regarding the need for the information itself.

One or more algorithms can be employed to determine formulaic descriptions of the assembly of the merchant categorization information, social media information, and optionally demographic and/or geographic information, using any of a variety of known mathematical techniques. These formulas in turn can be used to derive or generate indexing using any of a variety of available analysis algorithms.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

The techniques described herein are exemplary, and should not be construed as implying any particular limitation on the present disclosure. It should be understood that various alternatives, combinations and modifications can be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
retrieving from one or more databases a first set of information, the first set of information comprising categorization of merchants;
retrieving from one or more databases a second set of information, the second set of information comprising social media information indicative of consumer sentiment of a merchant for a defined time period;
generating one or more indices based on the first set of information and the second set of information; and
assessing consumer sentiment of a merchant based on the one or more indices.

2. The method of claim 1, wherein the one or more indices are a measure selected from the group consisting of a measure of the degree to which: merchant positive sentiment and merchant overall sentiment are correlated for the defined time period, industry positive sentiment and industry overall sentiment are correlated for the defined time period, and merchant positive sentiment and industry positive sentiment are correlated for the defined time period.

3. The method of claim 1, further comprising algorithmically generating the one or more indices based on the first set of information and the second set of information.

4. The method of claim 1, wherein the categorization of merchants is by industry sector.

5. The method of claim 1, wherein the first set of information includes industry categories selected from:

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| and | |
| WHT | Wholesale Trade. |

6. The method of claim 1, wherein the second set of information is retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines.

7. The method of claim 1, wherein the second set of information is generated by:
collecting, using a computing device, a plurality of social media posts relating to at least one merchant; and
analyzing, using the computing device, a consumer sentiment of the at least one merchant expressed in each of the plurality of social media posts.

8. The method of claim 7, further comprising:
categorizing, using the computing device, each of the plurality of social media posts into the at least one topic;
categorizing, using the computing device, users associated with each of the plurality of social media posts into at least one demographic category;
archiving, using the computing device, each of the plurality of social media posts to a database stored on a computer readable medium;
indexing, using the computing device, each of the plurality of social media posts stored on the computer readable medium by the respective sentiment, the at least one topic and the at least one demographic category of each of the social media posts.

9. The method of claim 7, wherein the plurality of social media posts are collected from a plurality of social media websites.

10. The method of claim 7, wherein collecting social media posts additionally comprises collecting user profiles and social connections of the users associated with the social media posts, and wherein the profiles and social connections are archived to the database in association with each of the social media posts to which they relate.

11. The method of claim 1, wherein consumer sentiment of the merchant is selected from positive, negative and neutral.

12. A system comprising:
one or more databases comprising a first set of information, the first set of information including categorization of merchants;
one or more databases comprising a second set of information, the second set of information including social media information indicative of consumer sentiment of a merchant for a defined time period;
a processor configured to:
generate one or more indices based on the first set of information and the second set of information; and
assess consumer sentiment of a merchant based on the one or more indices.

13. The system of claim 12, wherein the one or more indices are a measure of the degree selected from the group consisting of a measure of the degree to which: merchant positive sentiment and merchant overall sentiment are correlated for the defined time period, industry positive sentiment and industry overall sentiment are correlated for the defined time period, and merchant positive sentiment and industry positive sentiment are correlated for the defined time period.

14. The system of claim 12, further comprising algorithmically generating the one or more indices based on the first set of information and the second set of information.

15. The system of claim 12, wherein the categorization of merchants is by industry sector.

16. The system of claim 12, wherein the first set of information includes industry categories selected from the group consisting of:

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| and | |
| WHT | Wholesale Trade. |

17. The system of claim 12, wherein the second set of information is retrieved from one or more sites selected from the group consisting of TWITTER, FACEBOOK, FOURSQUARE, GOOGLE+, YELP, AMAZON.COM customer reviews, FOURSQUARE, PINTEREST, PATCH.COM, ANGIESLIST.COM, EPINIONS.COM, newspapers, and/or magazines.

18. The system of claim 12, wherein the second set of information is generated by:
collecting, using a computing device, a plurality of social media posts relating to at least one merchant; and
analyzing, using the computing device, a consumer sentiment of the at least one merchant expressed in each of the plurality of social media posts.

19. The system of claim 18, further comprising:
categorizing, using the computing device, each of the plurality of social media posts into the at least one topic;
categorizing, using the computing device, users associated with each of the plurality of social media posts into at least one demographic category;
archiving, using the computing device, each of the plurality of social media posts to a database stored on a computer readable medium;
indexing, using the computing device, each of the plurality of social media posts stored on the computer readable medium by the respective sentiment, the at least one topic and the at least one demographic category of each of the social media posts.

20. The system of claim 18, wherein collecting social media posts additionally comprises collecting user profiles and social connections of the users associated with the social media posts, and wherein the profiles and social connections are archived to the database in association with each of the social media posts to which they relate.
